(19) United States
(12) Patent Application Publication
(10) Pub. No.: US 2018/0072198 A1
(43) Pub. Date: Mar. 15, 2018

(54) CHILD CAR SEAT WITH SYSTEM FOR DOUBLE-THRESHOLD TRIGGERING OF ACTIVE PROTECTION MEANS

(71) Applicant: DOREL FRANCE, CHOLET CEDEX (FR)

(72) Inventors: Nicolas GARNIER, Saint Germain Sur Moine (FR); Francois RENAUDIN, Cholet (FR); Alexandre QUARREY, Cran Gevrier (FR)

(21) Appl. No.: 15/560,203

(22) PCT Filed: Mar. 3, 2016
(86) PCT No.: PCT/EP2016/054600

§ 371 Date: Sep. 21, 2017

(30) Foreign Application Priority Data
Mar. 23, 2015 (FR) 1552404

(51) Int. Cl. B60N 2/28

(52) U.S. Cl. CPC B60N 2/2884; B60N 2/43

(57) ABSTRACT

A child car set includes an accident-detection system and a child-protection system that is active during a situation detected by the accident-detection system. The child car seat includes a system for triggering the child-protection system based on acceleration measurement.

### CROSS-REFERENCE TO RELATED APPLICATIONS

This application is a U.S. national counterpart application of international application serial No. PCT/EP2016/054600 filed Mar. 3, 2016, which claims priority to French Patent Application No. 1552404 filed Mar. 23, 2015.

### FIELD OF THE INVENTION

The field of the invention is that of child care, and more precisely of seats intended to be installed in a vehicle, hereinafter referred to as child car seats.

Even more precisely, the invention relates to car seats provided with means of protection, or of safety, that are active, and for example inflatable bags (“airbags”), implemented, or activated, in an accident situation.

### BACKGROUND

Child car seats are designed to provide optimum protection of the child in the case of an accident, as much as possible regardless of the impact that the vehicle is subjected to.

This protection is generally provided, at least partially, by so-called passive absorption elements (more precisely “passive during the accident”). These absorption elements can in particular be elements made from materials of the expanded polystyrene (PSE) type, which can absorb all or a portion of the impact. These absorption elements are generally in direct or quasi direct contact with a portion of the body of the child (for example the back, the shoulders, the head, etc.).

In addition, an active protection (more precisely “active during the accident”) can be implemented. These active means of protection can in particular be one or several airbags, such as described for example in the document of patent FR2969055, in the name of the Holder of this patent application.

Many documents describe such airbags suited for child car seats. However, there are no, currently, such seats on the market.

This is probably due, at least partially, to the difficulty in implementing such active means. Indeed, these active means require a detection of collision, or of deceleration, in order to trigger for the intended purpose and sufficiently rapidly the systems making it possible to protect the child.

Such means for triggering are generally available in motor vehicles, to act on the safety systems suited for adults installed in the vehicle. The vehicle is provided with many sensors, and powerful means of processing, able to effectively decide if active means of safety must be triggered.

These means proper to the vehicle cannot however be used directly by a child car seat. Indeed, a child car seat is intended, by nature, to be installed in different types of vehicles. Inversely, a vehicle can receive different types of child car seats. In the absence of a particular standard, it is therefore not possible to make use of the data collected and processed by the vehicle.

Consequently the system for detecting a collision, impact or deceleration, intended to trigger the active means of protection of a child car seat must be autonomous and proper to the latter.

The documents describing active safety systems, and in particular airbags, for car seats generally provide for the presence of means for detecting impacts, that control the triggering of airbags, but do not provide any precision on the operation of these means, and in particular on the way in which the measurements are taken and used. This is however a crucial problem. Indeed, it is essential that the active means are triggered systematically when this is necessary, and sufficiently rapidly in order to provide for the protection of the child.

However, inversely, it is also important that untimely triggerings be avoided, as much as possible, for reasons of safety (an untimely triggering can injure the child) as well as for obvious reasons of cost (active systems are generally single use, and they require a replacing of the seat, or at least of the active protection means, following a triggering).

Other difficulties linked to the fact that the car seat has to operate autonomously must be taken into account, such as the electrical power supply of the means for detecting and for actuating.

### SUMMARY

The invention has in particular for an objective to provide an effective solution to at least some of these various problems.

In particular, according to at least one embodiment, an objective of the invention is to provide a car seat that provides a reliable, safe and effective triggering of the active means of protection, when an accident situation occurs.

In particular, the invention has for objective, according to at least one embodiment, to provide such a car seat, that prevents as much as possible unnecessary or untimely triggerings, while still guaranteeing maximum protection of the child transported, in case of need.

Another objective of the invention is, according to at least one embodiment, to provide such a car seat, wherein the electrical consumption is optimised.

The invention also has for objective, according to at least one embodiment, to provide such a car seat, having means for triggering that are simple to be carried out and implement, and where applicable to adjust, and which are relatively inexpensive.

For this, the invention proposes a child car seat, comprising means for detecting an accident situation, activating active means of protection of the child in case of need. According to the invention, said means of detecting deliver an activation signal of said active means of protection according to an analysis of the measurements delivered by at least one element for measuring an acceleration, said means of detecting delivering such an activation signal if at least the two of the following conditions are fulfilled:
said acceleration is greater than a first threshold during a first interval of time; and
said acceleration is greater than a second threshold during a second interval of time,

said second threshold being greater than said first threshold and said second interval of time being less than said first interval of time and included in said first interval of time.

As such, according to this aspect of the invention, unnecessary, and even dangerous, triggerings of the active protection means are prevented, when the car seat is subjected to a brief impact which is not caused by an accident situation, for example an impact of the kick type received on the shell of the car seat.

According to a particular embodiment of the invention, said first threshold is between 3 g and 15 g and said second threshold is between 5 g and 20 g (g designating here and in the rest of the document the unit of acceleration that corresponds approximately to the acceleration due to gravity on the surface of the Earth: 1 g=9.80665 m·s-2).

According to a particular embodiment of the invention, the minimum duration of said first interval of time is between 3 and 20 ms and the minimum duration of said second interval of time between 0.5 and 5 ms.

According to a particular embodiment, said means of detecting include at least one electronic accelerometer and a microcontroller.

As such the microcontroller can be programmed to carry out the analysis of an acceleration measured by the electronic accelerometer, and deliver said activation signal of said active means of protection of the child in case of the detection of an accident situation. This microcontroller integrates in particular functionalities for measuring time (or “timer”) which allow it to determine if the level of information on acceleration provided on one of its input terminals is greater than one or several given thresholds during at least one given time.

According to a particular embodiment, said car seat comprises means of electrical power that combine at least one battery and at least one capacitor acting as a complement of said battery.

As such, the battery makes it possible not only to electrically power the electronic circuit for detecting an accident situation, but also to maintain charged one or several capacitors able to fulfil different functionalities (backup power supply, energy reserve for the activation of specific functionalities, etc.).

Advantageously, a first capacitor is mounted between a locking sensor of an Isofix® clip and the microcontroller, in such a way as to overcome a possible micro-interruption in the signal delivered by said locking sensor which could occur in case of impact, and block the triggering of the active means of protection of the child. The capacitor then acts as a backup power supply, making it possible to maintain the electronic circuit powered during a sufficient amount of time to allow for the analysis of a potential accident situation and the possible triggering, where applicable, of the active means of protection of the child.

According to a particular embodiment, said car seat comprises a second capacitor, delivering the power required for the activation of at least one pyrotechnic charge.

As such, the association of a simple battery and a capacitor is sufficient to provide for the delivery of sufficient electrical power to activate the pyrotechnic charge required for the deployment of the active means of protection of the airbag type (inflatable safety elements), in case of detection of an accident situation.

According to a particular embodiment, said means of detecting are powered only if at least one of the following conditions is satisfied:
the Isofix® clips are locked;
the buckle of the harness of the car seat is closed;
the presence of a child in the car seat is detected.

As such, the risk of untimely triggering (undesired) of the active means of protection of the child is reduced, and the device saves more energy, which provides it with a substantial lifespan without changing the battery.

According to different embodiments of the invention, said active means of protection include at least one of the means belong to the group comprising:
inflatable safety elements;
means for blocking or increasing the tension of a “top tether” strap, or anti-tilt strap, intended to attach an upper portion of said seat and an anchoring point in said vehicle;
means for blocking or increasing the tension of the harness straps of said car seat, intended to maintain a child in said seat;
means for blocking or increasing the tension of a liaison strap between a base and a seat mobile in rotation in relation to said base;
means of rectifying the seat back of said car seat;
means for deploying an anti-submarining device;
means for compressing the child seat on a seat or a bench seat of the vehicle, on lower Isofix® anchorings;
means for modifying the inclination of the seat by the intermediary of a supporting leg.

According to another aspect, the invention also relates to a method for detecting an accident situation in a child car seat, activating active means of protection of the child, delivering an activation signal according to an analysis of the measurements delivered by at least one element for measuring an acceleration, said method comprising the following steps:
obtaining of at least one measurement of acceleration;
analysis of said measurement, and
delivery of an activation signal if at least the two following conditions are satisfied:
   said acceleration is greater than a first threshold during a first interval of time; and
   said acceleration is greater than a second threshold during a second interval of time,

said second threshold being greater than said first threshold and said second interval of time being less than said first interval of time.

According to yet another aspect, the invention relates to one or several computer programs comprising instructions for the implementation of a method for detecting an accident situation in a child car seat such as described hereinabove, when this or these programs are executed by a processor.

The various characteristics of this invention can be implemented in the form of a system, devices, methods, or supports that can be read by a computer. Consequently, the various characteristics of this invention can take the form of an embodiment that is entirely hardware, entirely software, or that combines hardware and software aspects.

Moreover, certain characteristics of this invention can take the form of a support for storage that can be read by a computer. Any combination of one or several supports for storage that can be read by a computer can be used.

### BRIEF DESCRIPTION OF THE FIGURES

Other characteristics and advantages of the invention shall appear when reading the following description of particular embodiments, given by way of simple, illustratory and non-exhaustive examples, and from the appended figures, of which:

FIG. 1 shows an example of a car seat provided with airbags, according to a particular embodiment of the invention;

FIG. 2 diagrammatically shows the two conditions required for the triggering of the active means of protection (double threshold mechanism) according to a particular embodiment of the invention;

FIG. 3 shows an example of an acceleration profile characteristic of an accident situation, according to a particular embodiment of the invention;

FIG. 4 shows an example of an electrical diagram for the detection of an accident situation and the triggering of the active means of protection of a child, according to a particular embodiment of the invention;

FIG. 5 shows the main steps carried out by the microcontroller, for the implementation of the method of detecting an accident situation, in a particular embodiment;

FIG. 6 describes a simplified architecture of a microcontroller able to implement the method of detecting an accident situation, according to a particular embodiment of the invention.

### DETAILED DESCRIPTION

The invention therefore relates to child car seats, provided with active means of protection, in consequence of means for triggering these active means of protection in case of need (impact, accident, deceleration greater than a predetermined threshold, etc.).

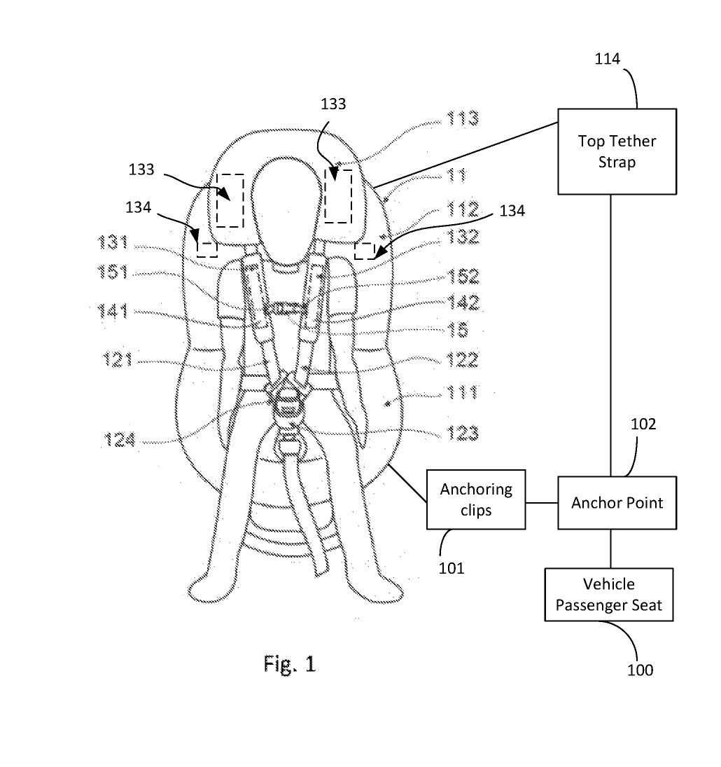

These various situations for which a triggering of the active means of protection is desired are grouped together under the term “accident situation” in the whole of this document. The active means of protection can for example include at least two inflatable safety elements (also called airbags) able to be inflated in the case of the detection of an accident situation, and means of fastening said inflatable safety elements with one another. This solution implementing two airbags that can be attached is presented in relation with FIG. 1, and is described in detail by the patent document FR2969055 already mentioned.

In an embodiment, this car seat comprises a harness 12 having two shoulder straps 121, 122 intended to extend from the shoulder along the torso of a child, and each one bearing an inflatable safety element 141, 142, housed in a sheath 131, 132 mounted respectively on the shoulder straps 121, 122, and able to be inflated in case of the detection of an accident situation. Alternatively, these inflatable safety elements can also be borne directly by the shoulder straps 121, 122.

These inflatable safety elements 141 and 142 are moreover connected by means of fastening 15, fastening them to one another, when the child is installed in the seat.

These means of fastening 15 include, in the embodiment shown, two flexible portions, or strips, 151 and 152, each provided with a respectively male and female buckle element, able to be inserted into one another in order to attach the two strips 151 and 152, and able to be separated from one another, by a suitable manual action (chosen in such a way that the child installed cannot himself unfasten these means of fastening).

According to this embodiment, the means of fastening 15 also provide the maintaining in a position that is sufficiently close of the two shoulder straps 121 and 122, when a child is installed in the seat (“chest clip” function). This makes it possible to guarantee that the shoulder straps are well placed, and to prevent the child from passing an arm under one of the shoulder straps and/or removing one of the shoulder straps while the harness is buckled.

According to another embodiment, these inflatable safety elements are not necessarily systematically attached to one another when a child is installed in the car seat, but only when an accident situation is detected. In this case, the means of fastening are controlled by the same activation signal as that which triggers the inflating of the inflatable safety elements, in such a way that an automatic attaching of the inflatable safety elements is implemented before or during the inflating.

The form of the airbags and/or the manner of which they are inflated can for example be suited in such a way that the means of fastening are directed towards each other during the inflating, and able to be attached without human intervention being required.

In yet another embodiment, the airbags are not necessarily borne by the shoulder straps or their sheaths, but are borne by the seat back 134 or the headrest of the car seat 133, in the vicinity of the head of the child. Here again, means of fastening of the airbags are provided, in order to prevent these bags from separating from each other, in particular when the head of a child comes into contact with them.

These safety elements, or bags, that are inflatable must be inflated rapidly, in case of an accident, in order to provide for the protection of the child. It is however important to prevent an untimely triggering of the airbags from being triggered, in particular when the seat is not correctly installed in the vehicle and/or when no child is present in the car seat. As such, patent document FR2997352, in the name of the Holder of this patent application, describes means for triggering, which are advantageously entirely borne by the car seat, and which take into account at least two separate pieces of information:
at least one first signal indicating an actual and/or correct use of the seat in the vehicle; and
at least one second signal, delivered by means for detecting, indicating the detection of an accident situation.

The purpose of the first series of signals is to prevent a triggering of the active protection means, even in the presence of an impact or an accident, if the latter is not necessary, or dangerous.

As such, it is desirable to prevent triggerings when the car seat is not installed in a vehicle (for example during the transport thereof or the storage thereof). It is also not desirable for the active protection means to be triggered if the car seat is not installed correctly, and for example maintained by its Isofix® clips. A first sensor of the correct locking, or of the correct installation of the seat in the vehicle (for example a sensor associated with the Isofix® clips) is provided, in order to deliver an information on the correct hooking of the latter to the rings provided for this purpose in the vehicle. Note as such that the equipment producing the first signal comprises according to the invention at least one locking sensor of the car seat to the vehicle, with this sensor being more preferably borne by the car seat.

It is moreover desirable that the active protection means not be triggered, even if the car seat is correctly installed in the vehicle, if the latter is not transporting a child.

According to a first approach, this detection can be provided by means of controlling the locking of the harness of the child in the car seat, and for example of the correct buckling of the thorax clip, connecting the two shoulder straps of the harness. This approach is in particular interesting in the case of the seat of FIG. 1, since this clip must also be locked, in an embodiment, in order to provide for the correct deployment of the airbags.

Other detectors of the presence of the child can be provided, alternatively or as a supplement, for example using a weight sensor built into the seat surface of the car seat.

It is then suitable to effectively detect an accident situation. This is provided through the detection of one or several predetermined deceleration thresholds, delivering first detection signals. The aforementioned patent document FR2997352 proposes several approaches in order to reach this objective.

According to a first approach, these means of detecting can be purely mechanical. This approach has the advantage of not requiring electrical power, which makes it possible to simplify the carrying out of the car seat, and to prevent the risks due to the necessity of an autonomous operation (which supposes the implementation of autonomous batteries, and the control of the sufficient load of the latter, to generate an alert in the opposite case). Such a mechanical system can in particular implement a preloaded spring, associated with a mobile flyweight, forming an inertial sensor. When the flyweight is displaced beyond a chosen threshold, the tension of the spring also exceeds a corresponding threshold, and a detection signal is generated. Other embodiments that make it possible to obtain a similar result can of course be used.

A disadvantage with this approach is that it does not allow for selective adjustment: a single preloading of the spring is possible. For safety, the predefined threshold must therefore be limited, which increases the risk of untimely triggering.

According to a second approach, it is possible to use electronic means of detection, implementing one or several accelerometers. This approach makes it possible to carry out a more precise detection, and consequently to have a programmable triggering threshold, according to various parameters. Consequently, the risk of untimely triggering can as such be reduced substantially.

On the other hand, this system must be on standby constantly, which supposes a supply of electrical power that is sufficient for the seat to be able to be used for several months/years.

According to a third approach, the aforementioned patent document FR2997352 provides to combine the first and second approaches described hereinabove, by confiding to the mechanical means a wakening function, or activation function, of the electronic means in case of a potential accident situation. As soon as they are activated, the electronic means carry out a more in-depth analysis, and more precise, of the situation, in order to decide if the potential accident situation is or is not an actual accident situation, requiring the triggering of the active protection means.

In other terms, the mechanical means react to a relatively low wakening threshold, encompassing a number of situations that do not require the triggering of the active protection means. As soon as the wakening threshold is crossed the mechanical means wake the electronic means, which analyse the situation, and decide the triggering, if the acceleration exceeds a triggering threshold. This third approach is particularly effective, since the power consumption is greatly reduced (as the electronic are powered only when they are “woken” by the mechanical means), and since all of the “at risk” or “potential accident” situations are detected thanks to the wakening threshold. The latter can be low, since it does not directly control the triggering of the means of protection. The implementation of electronic means, as a supplement, validate the “actual accident” situation, requiring the triggering of the means of protection, or decide that it is a “false alert”, according to a fine analysis of the measurements delivered by one or several electronic accelerometers, and where applicable different parameters making it possible to adapt the second threshold, or triggering threshold.

Interest is given in this application to the fine analysis functionality of the measurements delivered by at least one element for measuring an acceleration, for example one or several electronic accelerometers.

After various static and dynamic tests, the inventors revealed that fact that the detection of a peak in acceleration alone was not a sufficiently reliable criterion to validate an “actual” accident situation and therefore decide the triggering of the active means of protection. Indeed, by way of example, they measured that a kick with the heel of an adult in a car seat generates on the seat a brief peak in acceleration (of about 2.5 ms) but substantial (acceleration exceeding 8 g). As such, with an analysis based on comparing an acceleration with a simple threshold, such an impact would be likely to trigger the active means of protection in an undesirable way, with all of the associated undesirable consequences (untimely triggering susceptible to injure the child, costs associated with replacing the active means of protection which are generally single use, etc.).

As such, if the detection of a peak in acceleration is a required condition in the process of detecting an accident situation, it is not sufficient and its implementation alone could lead to the untimely triggering of the active means of protection (this is also referred to as a “false positive” in order to characterise such cases of untimely triggering).

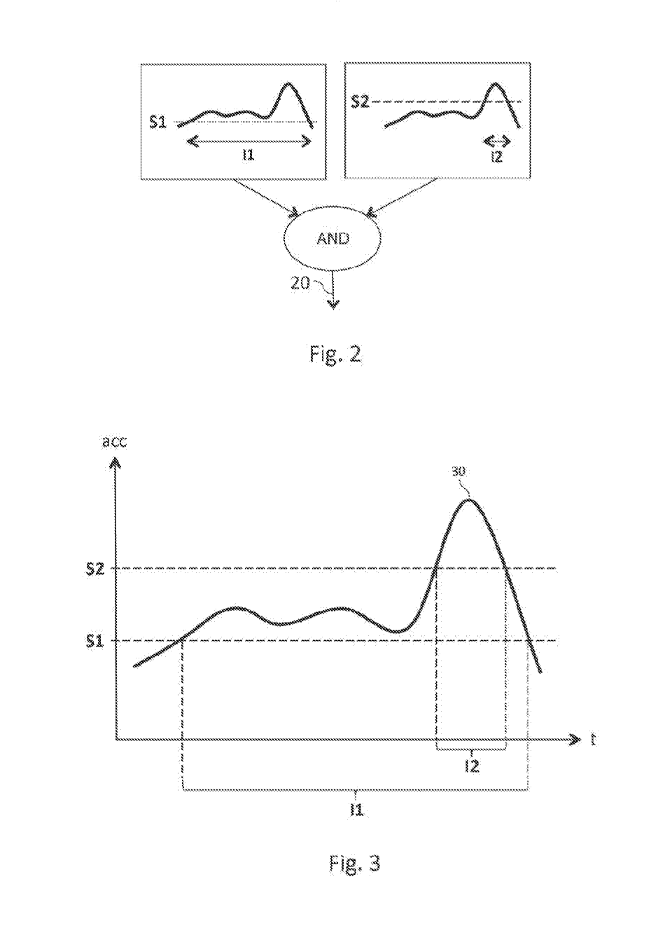

To overcome this problem, the invention proposes a double threshold triggering system of the active means of protection. According to the technique proposed, the activation signal (20) of the active means of protection is delivered only if at least both of the following conditions, shown diagrammatically in relation with FIG. 2, are satisfied:
the acceleration is greater than a first threshold (S1) during a first interval of time (I1); and
the acceleration is greater than a second threshold (S2) during a second interval of time (I2).

According to the technique proposed, the second acceleration threshold is greater than the first threshold, and the second interval of time is of a duration shorter than that of the first interval of time, and is included in said first interval of time.

In other terms, the detecting of an accident situation is based not only on the presence of what can be assimilated with a peak in acceleration (an acceleration greater than the second threshold during the second interval of time), but also on the detection of a lesser acceleration but of a longer duration (an acceleration greater than the first threshold—said first threshold being less than the second threshold—during a first interval of time encompassing the second interval of time).

FIG. 3 shows an example of an acceleration profile of a car seat that satisfies the triggering conditions of the active means of protection of the child who is installed therein, according to the technique proposed. Indeed, a peak in acceleration (30) is detected (acceleration exceeding the threshold S2 during the interval of time I2), but also a lesser acceleration but nevertheless abnormally high (greater than the threshold S1, said threshold S1 being less than the threshold S2) during an interval of time I1 greater than I2, and which contains I2.

The static and dynamic tests conducted by the inventors made it possible to characterise the values of the thresholds and the duration of the intervals in such a way as to optimise the detection of accident situations: the threshold Si is as such ideally between 3 g and 15 g (for example 7 g), and the threshold S2 between 5 g and 20 g (for example 15 g); the interval of time I1 associated with threshold S1 has a minimum duration between 3 ms and 20 ms (for example 10 ms), and the interval I2 associated with threshold S2 a minimum duration between 0.5 ms and 5 ms (for example 3 ms). With the values given in the previous example, an accident situation is therefore detected when a car seat is subjected to an acceleration that exceeds 7 g for at least 10 ms, and when during this range of acceleration exceeding 7 g for at least 10 ms it is also subjected to an acceleration exceeding 15 g for at least 3 ms.

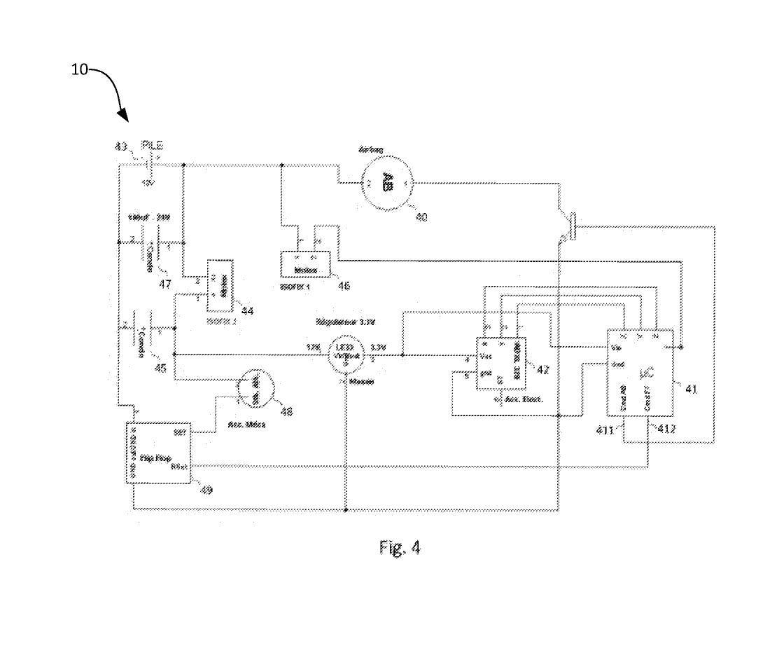

An example of an electronic circuit able to implement this invention is shown, in relation with FIG. 4. In the particular embodiment proposed here, the car seat is installed in the vehicle by means of two Isofix® clips 101 (Isofix® 1 and Isofix® 2), and some airbags act as active means of protection of the child. The inflating of these bags is triggered by the activation of associated pyrotechnic charges (40). A microcontroller (41) is used to analyse the acceleration measurements of the car seat, said measurements being supplied by an electronic accelerometer (42). A battery (43) is used to supply the various components of the circuit.

In order to prevent any triggering of the system if the car seat is not installed in the vehicle, or if it is not installed correctly, one of the Isofix® clips (here Isofix® 2) is provided with a locking sensor (44) mounted between the battery (43) and the rest of the circuit. This locking sensor (44) acts as a switch that allows the current to flow only if the Isofix® clip is correctly attached to its point of anchoring 102: as such, the overall electronics are supplied with current only if the Isofix® 2 clip is locked. In order to overcome a possible micro-interruption of the signal delivered by such a locking sensor which could occur in an accident situation, a first capacitor (45) is mounted between this locking sensor (44) and the rest of the electronic circuit. It is maintained charged by the battery (43) as long as the locking sensor (44) detects that the Isofix® 2 clip is correctly attached to its point of anchoring. In the opposite case, it takes the relay over the battery (43) in such a way as to maintain the power supply of the electronic circuit during a duration that is sufficient to allow for the analysis of a potential accident situation and the possible triggering, when applicable, of the active means of protection of the child (for example 100 ms).

The other Isofix® clip (Isofix® 1) is also provided with a similar locking sensor (46) mounted between the battery (43) and an input of the microcontroller (41). In this way, when it is powered, the microcontroller (41) is able to verify that the second Isofix® clip is correctly attached to its anchoring point, via a simple control of the voltage applied on one of its input terminals. In the opposite case, the microcontroller (41) will not deliver an activation signal of the active means of protection of the child.

As such, the active means of protection can be triggered only if the two Isofix® clips are locked, in other words when the car seat is correctly installed in a vehicle on a vehicle passenger seat 100.

When the two Isofix® clips are locked (i.e. correctly attached to their point of anchoring), the microcontroller (41) analyses the acceleration measurements of the car seat provided by the electronic accelerometer (42). Using a specific algorithm, it determines if the conditions of the technique proposed are satisfied, namely the detection of an acceleration greater than a first threshold during a first interval of time and greater than a second threshold during a second interval of time (with the second threshold being greater than the first threshold, and the second interval of time being of a duration less than that of the first interval of time, and included in said first interval of time). If this is the case, it is then considered that this is an accident situation and the microcontroller (41) delivers an activation signal of the active means of protection of the child on its output (411).

In the case of this example, airbags act as an active means of protection of the child. The battery used to supply the electronic system with power is generally not powerful enough to provide for the activation of the pyrotechnic charge required to release the gas that will inflate bags in case of an accident. As such, this battery is associated with a second capacitor (47) that it maintained charged. It is this second capacitor (47) which is charged with providing the power required to activate the pyrotechnic charge (40) used to inflate bags in the case of detection of an accident situation.

In order to control the needs in terms of energy of the system and as such guarantee a lifespan of several years without changing the battery (typically at least ten years), the electronic circuit proposed also contains the components required for the implementation of the technique proposed in the third approach of the aforementioned patent document FR2997352, namely a mechanical accelerometer (48) and a “flip-flop” case (49). When the mechanical accelerometer detects an acceleration greater than a predetermined relatively low threshold (less than the thresholds S1 and S2 of this invention), it delivers a signal on the input terminal “set” for the flip-flop case (49), which will then allow the supplying of the rest of the circuit, and in particular that of the electronic accelerometer (42) and of the microcontroller (41) (this is then referred to as “waking” of the electronic system). Once the electronic system has been woken, the microcontroller (41) proceeds with analysing the acceleration measurements supplied by the electronic accelerometer (42) in order to determine if an accident situation is detected. If this is the case, it delivers the activation signal of the active means of protection of the child on its output (411). In the opposite case, it delivers an extinction signal on its output (412), intended for the flip-flop case, which then is charged to cut off the power and as such turn off the system.

It will of course appear clearly to those skilled in the art that this electronic circuit shown in relation with FIG. 4 is an example provided solely for the purposes of illustration and not limiting for the implementation of the invention: in addition to this particular embodiment, many other electronic circuits different from the one described here are able to fulfil the same role.

In addition to or alternatively to the locking sensors of the Isofix® clips, other sensors can be used to cut off the power supply of the means for detecting an accident situation, and as such avoid their untimely triggering while still optimising the needs in terms of power of the system. It can be mentioned, for the purposes of information but not limiting of such sensors, a locking sensor of the harness of the car seat, or a weight sensor able to detect if a child is effectively installed in the car seat.

In order to provide for the safety of the child, the detection must be carried out very rapidly and the command to trigger must be issued more preferably between 3 and 80 milliseconds after the impact. The tests carried out show that the combination of the mechanical and electronic means make it possible to achieve this result.

In order to obtain a rapid, and precise, detection of the deceleration corresponding to an impact, the means of detecting are preferably placed as close as possible to the anchoring points of the vehicle (Isofix® rings), as it is these elements that first receive the deceleration due to the collision. As such, the means of detecting can be placed in the base, in the vicinity of the Isofix® clips, or even all or partially directly on or in these Isofix® clips.

More generally, a plurality of sensors (for example accelerometers) and/or fuses can be installed on the car seat, its base, and/or an associated supporting leg, and as such participate in refining the analysis of a potential accident situation in order to determine if the active means of protection of the child have to be triggered. Specific sensors can also be used to determine if the impact is frontal or lateral.

In other particular embodiments of the invention, signals supplied by the vehicle wherein the car seat is installed are used to improve the analysis of a potential accident situation, or in order to directly control the implementation of the active means of protection of the child. Indeed, many vehicles include active means of protection for their occupants (such as airbags), and consequently have their own means of detecting an accident situation. The corresponding signals can then be transmitted from the vehicle to the car seat, so that the latter uses them to trigger its own active means of protection of the child.

Although the embodiment described in relation with FIG. 1 shows the triggering of airbags, the approach of the invention can of course be implemented, as a supplement or as an alternative, to provide the triggering of other types of active protection means, such as:
means for blocking or increasing the tension of a “top tether” strap 114, or anti-tilt strap, intended to attach the upper portion of said seat and an anchoring point in the vehicle;
means for blocking or increasing the tension of the harness straps of said car seat, intended to maintain a child in the seat;
means for blocking or increasing the tension of a liaison strap between a base and a mobile seat in rotation in relation to the base;
means of rectifying the seat back of the car seat;
means for deploying an anti-submarining device;
means for compressing the child seat on a bench seat of the vehicle on lower Isofix® anchorings;
means for modifying the inclination of the seat by the intermediary of a supporting leg.

According to another aspect of the invention, the car seat comprises indicator means, that specify if the active protection means have been triggered and/or preventing the utilisation of said car seat if said active protection means have been triggered.

This makes it possible to notice, and/or to render unusable, a car seat that has been subjected to a triggering of the active protection means. Indeed, most of the active protection means are of single use, and the car seat must then no longer be used, or at the least be controlled and/or repaired.

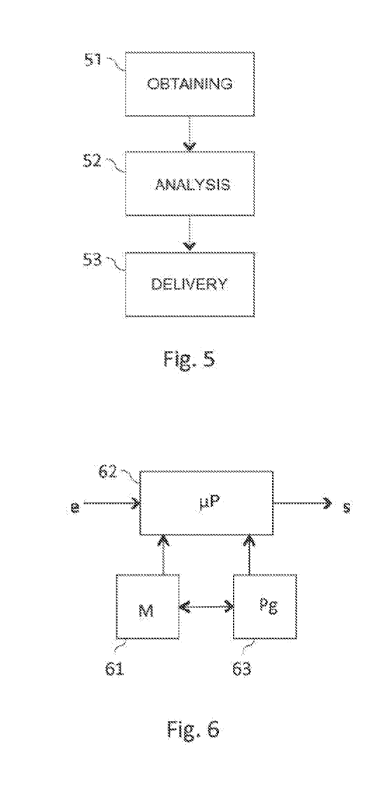

According to another aspect, the invention also relates to a method for detecting an accident situation in a child car seat, activating active means of protection of the child, delivering an activation signal according to an analysis of the measurements delivered by at least one element for measuring an acceleration, said method being characterised in that it comprises the following steps, in relation with FIG. 5:
obtaining (51) of at least one measurement of acceleration;
analysis (52) of said measurement, and
delivery (53) of an activation signal if at least the two following conditions are satisfied:
   said acceleration is greater than a first threshold during a first interval of time; and
   said acceleration is greater than a second threshold during a second interval of time,

said second threshold being greater than said first threshold and said second interval of time being less than said first interval of time.

This method is for example implemented within a microcontroller, of which a simplified architecture is proposed in relation with FIG. 6. Such a microcontroller comprises a memory (61) constituted of a buffer memory, a processing unit (62), provided for example with a processor, and controlled by the computer program (63), implementing the method for detecting an accident situation according to the invention. At the initialisation, the instructions of code of the computer program (63) are for example loaded into a memory before being executed by the processing unit (62). The processing unit (62) receives as input (e) measurements taken by at least one accelerometer. The microprocessor of the processing unit (62) then carries out the steps of the method for detecting an accident situation according to the invention, according to the instructions of the computer program (63) in order to deliver as output (s) either an activation signal of the active means of protection of the child (if an accident situation is detected), or an extinction signal of the electronics (in the opposite case).

A child care device 5 has a child holder including a child car seat 11 adapted to set on a passenger set in a vehicle 11 and a child restraint harness 12 associated with the child car seat 11 as suggested in FIG. 1. The child restraint harness 12 is formed to include a first shoulder strap 121 and a second shoulder strap 122 arranged to lie alongside and in spaced-apart relation to the first shoulder strap to provide a neck-receiving space 120 therebetween through which the neck of a child extends when the child-restraint harness 12 is worn by a child seated on the child car seat 11 as suggested in FIG. 1.The device includes one or more inflatable safety elements 131, 132, 133, 134, coupled to the child car seat 11, the one or more inflatable elements being to change from a compact storage shape to a relatively larger expanded use shape so as to cause each of the one or more inflatable elements to deploy and cushion the head of a child seated in the child car seat and restrained by the child-restraint harness. The child care device includes means 10 for activating the one or more inflatabale elements to assume the relative larger expanded use shape in response to generation of an activation signal indicative of exposure of the child car seat to an acceleration in excess of a predetermined first level for a predetermined first period of time and exposure of the child car seat to an external acceleration in excess of a predetermined second level for a predetermined second period of time, the predetermined second period of time is a subset of the predetermined first period of time. The means 10 further comprise detection means for detecting the acceleration and predetermined first and second time periods. The detection means comprises an accelerometer 42 and a microcontroller 41. The child car seat further has two anchoring clips 101, and the microcontroller 41 is only powered when a first anchoring clip 101 is attached to an anchor point 102 as sensed 46 and as seen in FIG. 4. The microcontroller 41 only sends the activation signal when a second anchoring clip 101 is sensed 44 to be attached to a second anchor point 102 as seen in FIG. 4.

1. Child car seat comprising active means of protection of the child and means for detecting an accident situation, said means for detecting comprising at least one accelerometer and delivering an activation signal to said active means of protection of a child, according to measurements delivered by said at least one accelerometer,
wherein said means for detecting comprise means for analysing said measurements, delivering said activation signal when at least following two conditions are satisfied:
acceleration is greater than a first threshold (S1) during a first interval of time (I1); and
acceleration is greater than a second threshold (S2) during a second interval of time (I2),
said second threshold (S2) being greater than said first threshold (S1) and said second interval of time (I2) being less than said first interval of time (I1) and included in said first interval of time (I1).

2. Child car seat according to claim 1, wherein said first threshold is between 3 g and 15 g and said second threshold is between 5 g and 20 g.

3. Child car seat according to claim 1, wherein said first interval of time is between 3 and 20 ms and said second interval of time is between 0.5 and 5 ms.

4. Child car seat according to claim 1, wherein said means for detecting comprise at least one electronic accelerometer and a microcontroller.

5. Child car seat according to claim 1, wherein said car seat comprises means of electrical power combining at least one battery and at least one capacitor acting as a supplement of said battery.

6. Child car seat according to claim 5, wherein said child car seat comprises a first capacitor mounted between a locking sensor of a seat-anchor clip and said microcontroller, to overcome a micro-interruption of a signal delivered by said locking sensor.

7. Child car seat according to claim 5, wherein said child car seat comprises a second capacitor, delivering the power required for the activation of at least one pyrotechnic charge.

8. Child car seat according to claim 1, wherein said child car seat said means for detecting are powered only if at least one of following conditions is satisfied:
seat-anchor clips are locked;
buckle of a harness of said child car seat is locked;
presence of a child in said child car seat is detected.

9. Child car seat according to claim 1, wherein said active means of protection comprise at least one of the elements belonging to the group comprising:
inflatable safety elements;
means for blocking or increasing tension of a top tether strap, or anti-tilt strap, intended to attach an upper portion of said child car seat and an anchoring point in a vehicle;
means for blocking or increasing tension of harness straps of said child car seat, intended to maintain a child in the child car seat;
means for blocking or increasing tension of a liaison strap between a base and a mobile seat in rotation in relation to said base;
means for rectifying the seat back of said child car seat;
means for deploying an anti-submarining device;
means for compressing the child car seat on a seat or a bench seat of a vehicle, on lower anchorings;
means for modifying inclination of the child car seat by the intermediary of a supporting leg.

10. Method for detecting an accident situation in a child car seat, for activating active means of protection of the child,
comprising following steps:
obtaining measurements of an acceleration;
analyzing said measurements, and
delivering an activation signal when at least two following conditions are satisfied:
acceleration is greater than a first threshold during a first interval of time; and
acceleration is greater than a second threshold during a second interval of time,
said second threshold being greater than said first threshold and said second interval of time being less than said first interval of time.

11. A non-transitory computer program comprising instructions for implementation of the method according to claim 10 when this program is executed by a processor.

12. A non-transitory computer-readable medium, non-removable, or partially or entirely removable, that can be read by a computer, and comprising instructions of a computer program for execution of the steps of the method according to claim 10.

13. Method according to claim 9, wherein the steps are implemented by an accelerometer and a microcontroller.

14. Method according to claim 9, wherein the second interval of time is included in the first interval of time.

15. Method according to claim 9, wherein the activating means are airbags in the child car seat and delivery of the activation signal activates a pyrotechnic charge to inflate the airbags.

16. A child care device comprising
a child holder including a child car seat adapted to set on a passenger seating a vehicle and a child-restraint harness associated with the child car seat and formed to include a first shoulder strap and a second shoulder strap arrange to lie alongside and in spaced-apart relation to the first shoulder strap to provide a neck-receiving space therebetween through which the neck of a child extends when the child-restraint harness is worn by a child seated on the child car seat,
safety elements coupled to the child car seat and configured to include one or more inflatable elements being activated to change from a compact-storage shape to a relatively larger expanded-use shape so as to cause each of the one or more inflatable elements to deploy and cushion the head of a child seated in the child car seat and restrained by the child-restraint harness, and
means for activating the one or more inflatable elements to assume the relatively larger expanded-use shape in response to generation of an activation signal indicative of exposure of the child car seat to an acceleration in excess of a predetermined first level for a predetermined first period of time and exposure of the child car seat to an external acceleration in excess of a predetermined second level for a predetermined second period of time, the predetermined second period of time being a subset of the predetermined first period of time.

17. The child care device of claim 16, wherein the means further comprises detection means for detecting the acceleration and predetermined first and second time periods.

18. The child care device of claim 17, wherein the detection means comprises an accelerometer and a microcontroller.

19. The child care device of claim 18, wherein the child car seat further comprises two anchoring clip and wherein the microcontroller is only powered when a first anchoring clip is attached to an anchor point.

20. the child care device of claim 19, wherein the microcontroller only sends the activation signal when a second anchoring clip is sensed to be attached to a second anchor point.
